(19) United States
(12) Patent Application Publication
(10) Pub. No.: US 2011/0186502 A1
(43) Pub. Date: Aug. 4, 2011

(54) COMBINATION TRAVELING WATER SCREEN APPARATUS

(75) Inventor: Myung-Keun Chang, Seoul (KR)

(73) Assignee: KC SAMYANG WATER SYSTEMS CO., LTD., Seoul (KR)

(21) Appl. No.: 12/600,837

(22) PCT Filed: Mar. 6, 2009
(86) PCT No.: PCT/KR2009/001119

§ 371 Date: Nov. 18, 2009

(30) Foreign Application Priority Data
Jan. 30, 2009 (KR) 10-2009-0007742

(51) Int. Cl. B01D 33/333; B01D 33/00

(52) U.S. Cl. 210/330

(57) ABSTRACT

Provided is a combination traveling water screening apparatus capable of improving collection and filtering efficiency of floating matters and reducing maintenance costs. The apparatus includes a frame (100), a motor (200) installed on the frame and providing a drive force, drive and driven sprockets (310) installed at both sides of the frame (100) and driven by the drive force transmitted from the motor (200), a carrying chain connecting the drive and driven sprockets (310) and circulated by the drive force, a plurality of screen baskets (500) circulated by the carrying chain (400) to filter and convey floating matters, a spray wash (700) for removing the floating matters in the screen baskets (500) using an injection pressure of fluid, and a through for collecting the floating matters dropped from the screen baskets, wherein each screen basket includes an upper plate (510), a lower plate (520) spaced apart a predetermined distance from the upper plate and bent upward at its front end, side plates (530) coupled to the upper and lower plates to cover both sides thereof, respectively, a plurality of vertical bars installed between rear sides of the upper and lower plates, and meshes installed behind the vertical bars.

### TECHNICAL FIELD

The present invention relates to a traveling water screening apparatus, and more particularly, to a combination traveling water screening apparatus capable of improving collection and filtering efficiency of various floating matters including marine life such as jellyfish, or municipal wastes, etc., and reducing maintenance costs.

### BACKGROUND ART

Generally, since seawater desalination plants or power generation plants collect seawater and use the seawater as raw water or cooling water in a cooling system, a water collecting port must include a variety of filtering apparatus for filtering floating matters such as shellfish, seaweed, marine life, municipal wastes, various garbage, etc., introduced with the seawater.

For example, in a bar-type screening apparatus shown in FIGS. 1 and 2, a frame 10 is installed at a civil structure of a water intake station, drive sprockets 30 are installed at both upper sides of the frame 10 to be connected to a motor 20, and driven sprockets 32 are installed at both lower sides of the water intake station. In addition, the sprockets 30 and 32 are connected to each other by a carrying chain 40, and screen baskets having a plurality of vertical bars 55 disposed in parallel at predetermined intervals are installed at the carrying chain 40.

In such a bar-type screening apparatus, the screen baskets 50 move depending on circulation of the carrying chain 40 to filter and pick up floating matters contained in raw water passing between bars of the screen baskets 50. As the screen baskets 50 pass an apex of the drive sprockets 30, they are inverted so that the floating matters having arrived at the apex are collected into a trough 80 or using a conveyor.

However, in such a bar-type screening apparatus, the screen baskets 50 having different intervals of the vertical bars 55 depending on raw water introduction types or the respective processing steps are alternately installed in a longitudinal direction of the apparatus in order to enable complete filtering using structural characteristics of the screen baskets 50, thereby sequentially collecting the floating matters in phases depending on their kinds and sizes. As a result, in consideration of a huge size of the screening apparatus, a flow speed of raw water and process amount and efficiency of the floating matters are poorly deteriorated, filtering efficiency of foreign substances is relatively decreased, and installation and maintenance costs are excessively consumed.

In particular, a dual flow-type screening apparatus, in which raw water is introduced through both sides of screen baskets and then discharged through one outlet port, is difficult to apply to the water intake station due to its structural characteristics.

Moreover, when a large amount of marine life such as jellyfish are introduced on a certain period due to climatic change due to global warming, or a large amount of municipal wastes and seaweed are introduced due to floodwaters or typhoons, the conventional bar-type screening apparatus cannot effectively block the introduction. As a result, stepback operations and shutdowns of a generator frequently occur, causing enormous economical losses.

For these reasons, the inventor(s) has/have conducted several years of research to develop a traveling water screening apparatus capable of improving filtering efficiency of floating matters and reducing maintenance costs in consideration of the above problems, and as a result, completed the present invention.

### DISCLOSURE OF INVENTION

### Technical Problem

In order to solve the foregoing and/or other problems, it is an aspect of the present invention to provide a combination traveling water screening apparatus capable of completely removing floating matters such as marine life, which are introduced in large quantities.

It is another aspect of the present invention to provide a combination traveling water screening apparatus capable of maximizing space utilization and reducing installation and maintenance costs.

### Technical Solution

One aspect of the present invention provides a combination traveling water screening apparatus including: a frame; a motor installed on the frame and providing a drive force; drive and driven sprockets installed at both sides of the frame and driven by the drive force transmitted from the motor; a carrying chain connecting the drive and driven sprockets and circulated by the drive force; a plurality of screen baskets circulated by the carrying chain to filter and convey floating matters; a spray wash for removing the floating matters in the screen baskets using an injection pressure of fluid; and a trough for collecting the floating matters dropped from the screen baskets, wherein each screen basket includes: an upper plate; a lower plate spaced apart a predetermined distance from the upper plate and bent upward at its front end; side plates coupled to the upper and lower plates to cover both sides thereof, respectively; a plurality of vertical bars installed between rear sides of the upper and lower plates; and meshes installed behind the vertical bars.

In addition, in the combination traveling water screening apparatus, seal plates may be installed between both sides of the carrying chain and the screen baskets to prevent the floating matters from passing therethrough.

Further, in the combination traveling water screening apparatus, the seal plates may have curved projections at their upper ends and recesses at their lower ends corresponding to the curved projections so that the seal plates are articulated with other adjacent seal plates to maintain sealing therebetween.

### Advantageous Effects

According to the present invention, vertical bars of screen baskets can primarily filter floating matters such as wood chips having certain size and strength and can secondarily filter floating matters such as underwater life passed through the vertical bars using meshes. Therefore, it is possible to stably pull up floating matters filtered and raised from underwater, in particular, foreign substances including flexible and slippery marine life such as seaweed or jellyfish which are introduced in large quantities, and completely remove them.

In addition, since a water intake station of the present invention is solely installed to simultaneously collect and treat various floating matters, it is possible to remarkably increase flow speed and treatment efficiency of raw water due to simplification and miniaturization of facilities. In particular, when it is applied to a water intake station having a dual flow-type screen, space utilization can be maximized, a facility site can be remarkably reduced, and installation and maintenance costs can be largely reduced.

Further, since upper and lower plates of screen baskets are formed of thin plates and bent and the vertical bars are fastened to upper and lower portions of the upper and lower plates using bolts, it is possible to reduce manufacturing costs of the screen baskets and maximize an effective area through which raw water passes.

### BRIEF DESCRIPTION OF DRAWINGS

FIG. 1 is a schematic side view of a conventional bar-type screening apparatus;

FIG. 2 is a front view of a carrying chain and a screen basket of the conventional bar-type screening apparatus;

FIG. 3 is a schematic front view of a combination traveling water screening apparatus in accordance with an exemplary embodiment of the present invention;

FIG. 4 is a schematic side view of the combination traveling water screening apparatus in accordance with an exemplary embodiment of the present invention;

FIG. 5 is an enlarged view of a portion A of FIG. 3;

FIG. 6 is an enlarged view of a portion B of FIG. 4;

FIG. 7 is a front view of a carrying chain and a screen basket in accordance with an exemplary embodiment of the present invention;

FIG. 8 is a side view of a specific portion of FIG. 7; and

FIG. 9 is an exploded perspective view of the specific portion of FIG. 7.

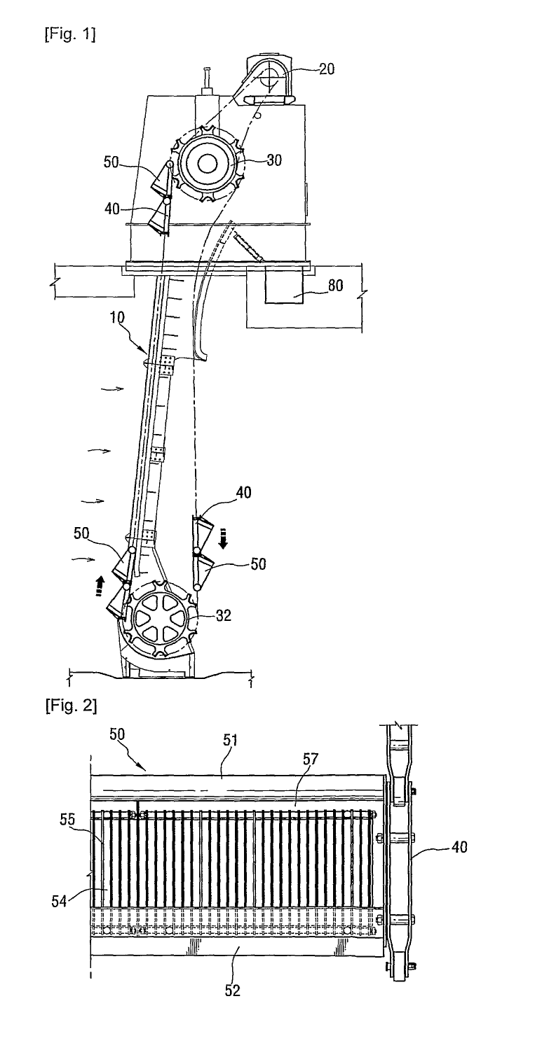

### DESCRIPTION OF MAJOR REFERENCE NUMERALS

100: Frame 200: Motor
212: First sprocket
300: Drive sprocket 310: Drive shaft
312: Second sprocket 320: Driven sprocket
330: Driven shaft 400: Carrying chain
410: Guide roller 412: Fixing pin
420: Link plate 421: Coupling hole
430: Fixing member 500: Screen basket
510: Upper plate 520: Lower plate
530: Side plate 531: Fastening hole
540: Through-hole 550: Vertical bar
560: Meshes 600: Seal plate
610: Curved projection 620: Recess
631: Through-hole 700: Spray wash
710: Nozzle 800: Trough
900: Chain guide rail

### MODE FOR THE INVENTION

Exemplary embodiments of the present invention will now be described in detail with reference to the accompanying drawings.

First, terms used herein are defined in consideration of functions in the present invention, and therefore, the terms will be construed as concepts corresponding to the spirit of the present invention and conventional meanings.

In addition, if already known functions or specific description of constitution related to the present invention may make the spirit of the present invention unclear, detailed description thereof will be omitted.

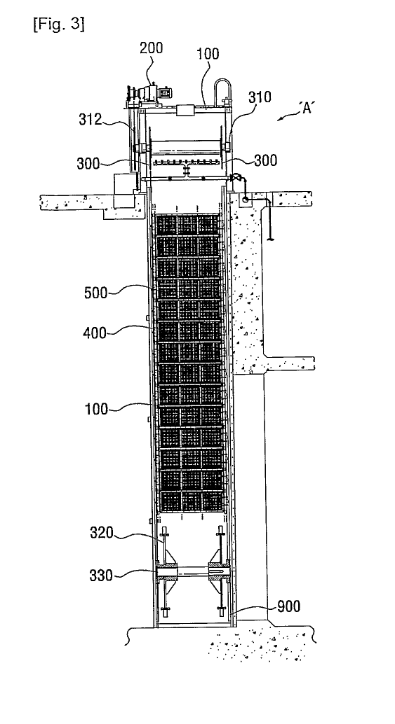

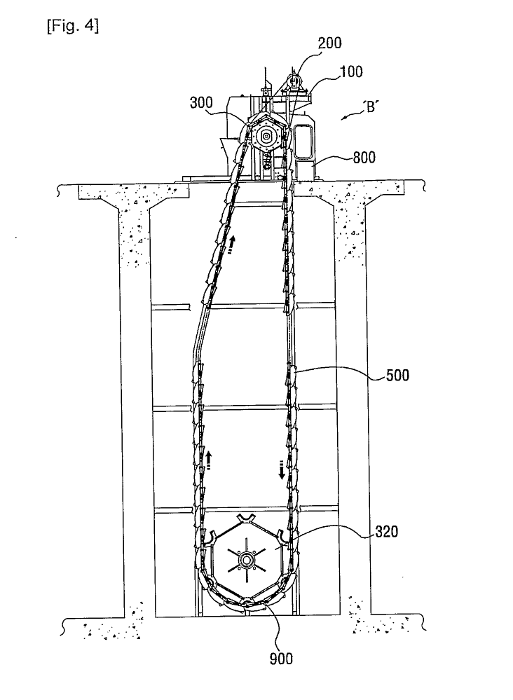

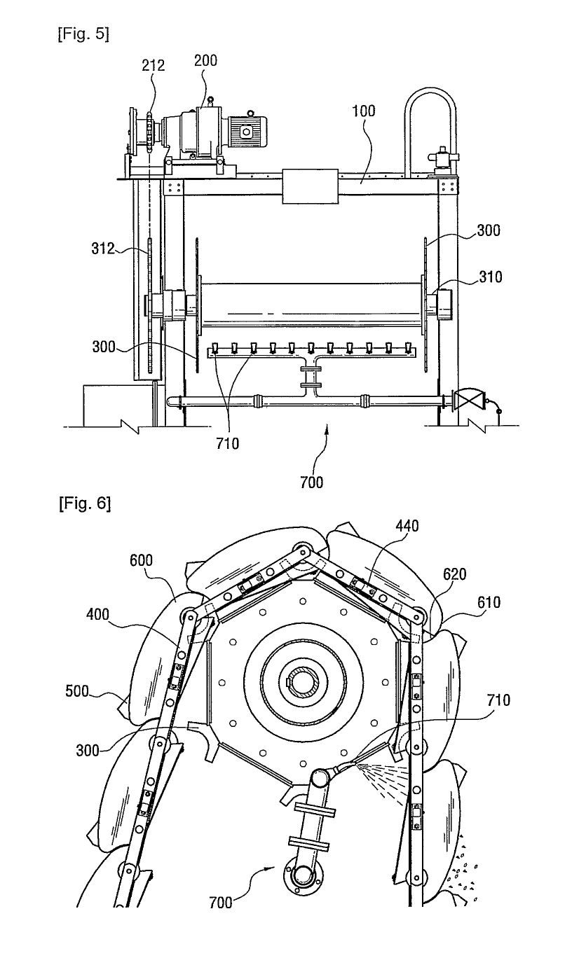

FIGS. 3 to 6 schematically show a combination traveling water screening apparatus in accordance with an exemplary embodiment of the present invention. As shown, the combination traveling water screening apparatus in accordance with an exemplary embodiment of the present invention includes a frame 100, a motor 200, drive and driven sprockets 300 and 320, a carrying chain 400, a screen basket 500, a spray wash 700, and a trough 800. The screen basket 500 includes an upper plate 510, a lower plate 520 spaced apart a predetermined distance from the upper plate 510 and bent upward at its front end, side plates 530 coupled to the upper and lower plates to cover both sides thereof, a plurality of vertical bars 550 installed between rear portions of the upper and lower plates, and meshes 560 installed in the rear of the vertical bars 550.

First, the frame 100 functions to maintain an external shape of the combination traveling water screening apparatus in accordance with an exemplary embodiment of the present invention and fix it to the water intake station.

The motor 200 is fixed to an upper end of the frame 100 to provide a drive force. A first sprocket 212 coupled to a rotary shaft of the motor is connected to a second sprocket 312 coupled to a drive shaft 310 of the drive sprocket 300 through a chain to transmit a rotational force to the drive sprocket 300 during operation of the motor 200.

The drive and driven sprockets 300 and 320 circulate the carrying chain 400 by a rotational force transmitted from the motor 200. Both ends of their drive and driven shafts 330 are supported by the frame 100 and take-up bearings (not shown). In addition, a capstan (not shown) connected to the drive shaft 310 is installed on the drive sprocket 300 to adjust tension of the carrying chain 400.

Here, a chain guide rail 900 is installed outside the driven sprocket 320. The chain guide rail 900 is securely fixed to the frame 100, and sealing rubber (not shown) is installed along a track of the guide rail to be in contact with the seal plate 600 and perform sealing upon operation or stoppage of the screen baskets 500.

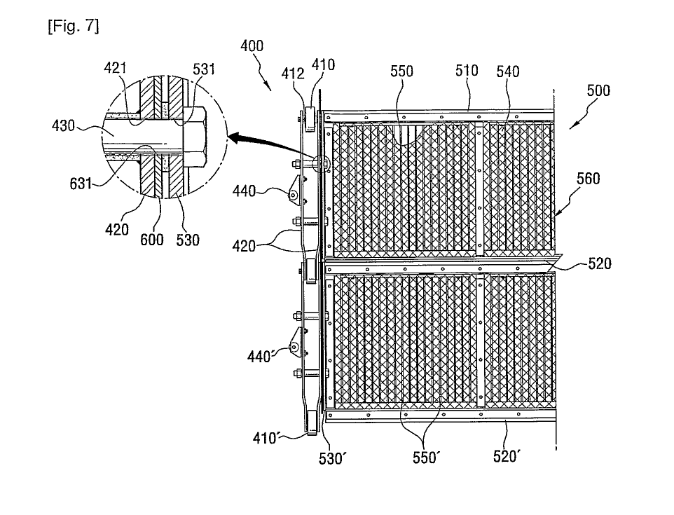

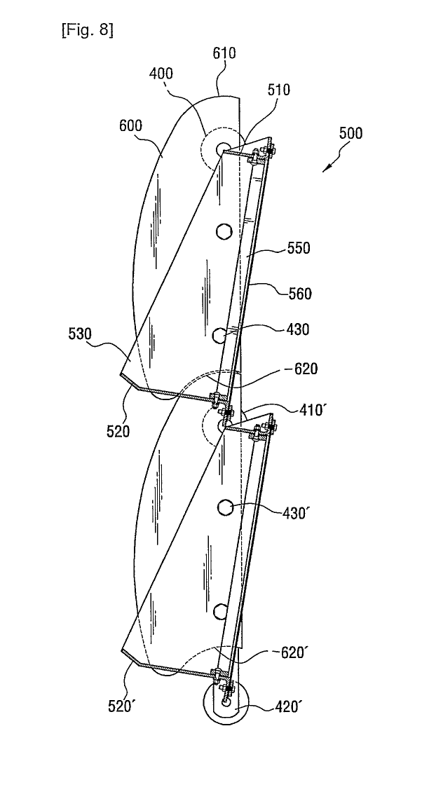

The carrying chain 400 circulates the screen baskets 500, and, as shown in FIGS. 7 and 8, guide rollers 410 rotated about fixing pins 412 are installed between both ends of a pair of left and right link plates 420 to be smoothly rotated by bushes. A plurality of coupling holes 421 are formed in side surfaces of the link plates 420 so that fixing members 430 can be fastened to fix the screen baskets 500.

In addition, side rollers 440 are installed at both side surfaces of the link plates 420 to maintain a predetermined gap from the chain guide rail 900.

Further, the guide roller 410 has a diameter larger than a width of the side surface of the link plate 420, and one facing ends of the link plates 420 are bent inward to reduce a distance between the one ends. Therefore, in a state in which one ends of the link plates 420 having a small distance are inserted between the other facing ends opposite to the one ends and having a large distance, the one ends and the other ends can be fixed with the guide rollers 410 by the fixing pins 412.

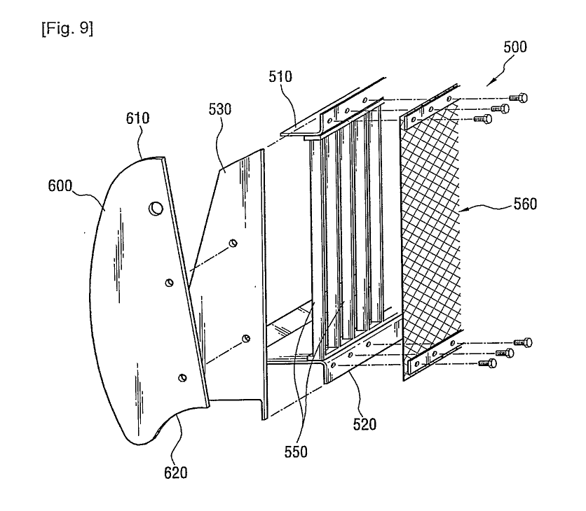

The screen baskets 500 function to convey the floating matters filtered from the seawater to the trough 800. As shown in FIGS. 7 to 9, each screen basket 500 includes an upper plate 510, a lower plate 520 having an upwardly bent front end, and side plates 530 coupled to the upper and lower plates 510 and 520 to cover their both side surfaces. The upper, lower and side plates 510, 520 and 530 form a through-hole 540 through which seawater passes. A plurality of vertical bars 550 are installed at the through-hole 540 at predetermined intervals to primarily filter floating materials such as wood chips, jellyfish, etc. Meshes 560 are detachably installed in the rear of the vertical bars 550 to secondarily filter floating matters such as jellyfish, etc.

Here, the vertical bars 550 may be bundled in plural units to be readily installed or mounted. The meshes 560 are weaved of a stainless steel wire having a diameter of 1 to 2 mm to form squares of 5 to 9.5 mm. The meshes 560 may be securely fixed by thin plates or bolts.

In addition, a plurality of fastening holes 531 are formed in the side plates 530, through which fixing members 430 are inserted to fix the side plates 530 to the link plate 420 of the carrying chain 400. Therefore, the fixing members 430 can be inserted and fastened through the fastening holes 531 and the coupling holes 421 formed in the link plates 420 so that the screen baskets 500 are securely fastened to the carrying chain 400.

The seal plates 600 are installed to prevent the floating matters from passing along between the carrying chain 400 and the screen baskets 500. In order to maintain sealing between the seal plates 600 through articulated coupling with another seal plate 600, a curved projection 610 is formed at an upper end of the seal plate 600, and a recess 620 is formed at a lower end of the seal plate 600 corresponding to the curved projection 610.

In addition, a plurality of through-holes 631 are formed in side surfaces of the seal plates 600, through which the fixing members 430 are inserted to fix the carrying chain 400 and the screen baskets 500. Therefore, when the screen baskets 500 are fastened to the carrying chain 400, the seal plates 600 can be fastened with the fixing members 430, and thus, it is possible to prevent floating matters contained in seawater from being introduced into a water introduction port, not passing through the screen baskets 500.

The spray wash 700 functions to remove the floating matters from the screen baskets 500 into the trough 800 using a fluid injection pressure. In order to readily remove the floating matters jammed between the vertical bars 550 and the meshes 560, nozzles 710 are disposed at the spray wash 700 at predetermined intervals.

Since the spray wash 700 can use a conventional fluid injection apparatus for injecting water pressure-pumped through a pump or nozzle through a high-pressure injection method, detailed description thereof will be omitted.

The trough 800 functions to collect the floating matters dropped from the screen baskets 500. The trough 800 is installed behind the carrying chain 400 to collect the floating matters dropped from the screen baskets 500 to discharge them to the exterior.

Here, the spray wash 700 and the trough 800 are covered with a separate splash housing (not shown) to prevent the floating matters dropped from the screen baskets 500 and wash-water injected from the spray wash 700 from being leaked to the exterior.

Hereinafter, operation of the combination traveling water screening apparatus in accordance with an exemplary embodiment of the present invention will be described.

First, when a separate controller sets the apparatus in an operation mode, power is applied to the motor 200, and the drive sprocket 300 connected to the motor 200 is rotated clockwise to circulate the carrying chain 400. Therefore, the screen baskets 500 fixed to the carrying chain 400 are raised in front of a water introduction port and lowered behind the water introduction port to filter raw water through the vertical bars 550 and the meshes 560 and then pass the filtered raw water therethrough. At this time, front portions of the screen baskets 500 filter foreign substances such as floating matters including wood chips and jellyfish, or seaweed, introduced with raw water and convey them upward.

The floating matters and foreign substances conveyed upward by the screen basket 500 are inverted downward at a point where the screen basket 500 passes an apex of a running path of the drive sprocket 300 and moves downward, to be dropped into the trough 800 due to their own weight. At the same time, the spray wash 700 injects wash-water toward the screen baskets 500 at a high pressure to completely remove the foreign substances such as seaweed, jellyfish, etc., jammed between the vertical bars 550 and the meshes 500. Therefore, when the screen baskets 500 are lowered to be submerged underwater, it is possible to prevent the floating matters and foreign substances such as jellyfish, seaweed, etc., which were moved upward, from being introduced underwater again.

In addition, the seal plates 600 installed along an interval between the screen baskets 500 and the carrying chain 400 prevent the foreign substances from passing through the screen baskets 500 and being introduced into the water collection port, thus remarkably improving filtering performance. That is, since the curved projections 610 and the recesses 620 correspondingly formed at upper and lower ends of the seal plates 600 maintain close contact therebetween even when they are rotated about the fixing pins 412, it is possible to maintain close contact therebetween, with no gap between adjacent seal plates 600 even where the screen baskets 500 are disposed in different directions.

Further, since the upper and lower plates 510 and 520 of the screen baskets 500 formed of thin plates are bent, it is possible to maximize an effective area through which raw water passes, and optimize treatment efficiency of the water intake station.

While few exemplary embodiments of the present invention have been shown and described, it will be appreciated by those skilled in the art that various changes may be made to these embodiments without departing from the spirit and scope of the invention as defined by the appended claims and their equivalents.

1. A combination traveling water screening apparatus comprising: a frame; a motor installed on the frame and providing a drive force; drive and driven sprockets installed at both sides of the frame and driven by the drive force transmitted from the motor; a carrying chain connecting the drive and driven sprockets and circulated by the drive force; a plurality of screen baskets circulated by the carrying chain to filter and convey floating matters; a spray wash for removing the floating matters in the screen baskets using an injection pressure of fluid; and a trough for collecting the floating matters dropped from the screen baskets, wherein each screen basket comprises:
an upper plate;
a lower plate spaced apart a predetermined distance from the upper plate and bent upward at its front end;
side plates coupled to the upper and lower plates to cover both sides thereof, respectively;
a plurality of vertical bars installed between rear sides of the upper and lower plates; and
meshes installed behind the vertical bars.

2. The combination traveling water screening apparatus according to claim 1, wherein seal plates are installed between the carrying chain and the screen baskets.

3. The combination traveling water screening apparatus according to claim 2, wherein the seal plates have curved projections at their upper ends and recesses at their lower ends corresponding to the curved projections.
